(19) United States
(12) Patent Application Publication
(10) Pub. No.: US 2025/0285201 A1
(43) Pub. Date: Sep. 11, 2025

(54) METHOD AND SYSTEM FOR SECURE, NON-REPUDIABLE REAL ESTATE TRANSACTION

(71) Applicant: Multi-Listing Platform LP, Toronto (CA)

(72) Inventors: John DiMichele, North York (CA); Paul McGowan, Toronto (CA); Carlos Grass, Scottsdale, AZ (US)

(21) Appl. No.: 18/598,705

(22) Filed: Mar. 7, 2024

(51) Int. Cl. G06Q 50/16; G06Q 20/38; G06Q 20/40; G06Q 20/42

(52) U.S. Cl. CPC G06Q 50/167; G06Q 20/38215; G06Q 20/389; G06Q 20/4014; G06Q 20/42

(57) ABSTRACT

A computerized method for securing and performing a transaction, the method including receiving, at a computing system from a first party, a request to start the transaction; verifying the identity and a role for the first party; identifying, from the request, a transaction type and parties to the transaction; starting a workflow for the transaction based on the transaction type; sending, based on the workflow, requests for information to the parties to the transaction; receiving the information; and storing the information in a blockchain for the transaction.

### FIELD OF THE DISCLOSURE

The present disclosure relates to tools for real estate transactions, and in particular relates to a secure platform & repository that can be used to track, monitor, store and extract data and documents from a real estate transaction in order to provide an immutable record and history of the transaction over time.

### BACKGROUND

Currently the real estate transaction process is very resource heavy, time consuming, inefficient and requires many manual actions in order for one transaction to be completed and the property conveyed.

Specifically, actors such as listing agents, buyer agents, brokerages, lawyers, inspectors, government or institutional departments, franchisors, stakeholders, banks or financial institutions, among others, need to all perform tasks that may need to be done in a certain order. The diverse tasks and time requirements lead to inefficient transactions that consume significant resources.

### BRIEF DESCRIPTION OF THE DRAWINGS

The present disclosure will be better understood with reference to the drawings, in which:

FIG. 1 is a block diagram showing an example system diagram.

FIG. 2 is a block diagram showing application program interfaces for use in accordance with the embodiments of the present disclosure.

FIG. 3 is a block diagram showing a blockchain model.

FIG. 4 is a block diagram showing data flow through the system.

FIG. 5 is a block diagram of an ingestor block.

FIG. 6 is a block diagram of a layers stack for the embodiments of the present disclosure.

FIG. 7 is a dataflow diagram of a transaction.

FIG. 8 is a block diagram of a simplified computing device capable of being used with the embodiments of the present disclosure.

### DETAILED DESCRIPTION OF THE DRAWINGS

In some aspects, the present disclosure may provide a computerized method for securing and performing a transaction. The method may include receiving, at a computing system from a first party, a request to start the transaction and verifying the identity and a role for the first party. The method may further include identifying, from the request, a transaction type and parties to the transaction, starting a workflow for the transaction based on the transaction type, and sending, based on the workflow, requests for information to the parties to the transaction. The method may further include receiving the information; and storing the information in a blockchain for the transaction.

In some embodiments, verifying the identity may be based on a single sign on and a credential identifying a user and a device.

In some embodiments the verifying may comprise receiving confirmation of identity from an authorized party within the computing system, sending a message to the first party to verify a communications channel; and sending a certificate for a computing device being used by the first party to the first party for manual or automatic installation on the computing device.

In some embodiments, the transaction requires information, the information being populated from a self-sovereign identity stored in a block on the blockchain.

In some embodiments, the method may further include, after the verifying, ensuring authorization for the transaction to proceed.

In some embodiments, the computing system may store a plurality of workflows for various transaction types.

In some embodiments, the method may further comprise, once the workflow is completed: sending a final agreement request to the first party and parties to the transaction; receiving confirmation from the first party and the parties to the transaction that the transaction is completed; and storing the completed transaction on the blockchain.

In some embodiments, the blockchain may be a private blockchain that is accessible through an application program interface on the computing system.

In some embodiments, the transaction may be a real estate transaction, and wherein the first party may be an agent, or any real estate professional and the parties to the transaction may include one or more of a buyer, a seller, a buyer's agent, a seller's agent, a brokerage, a lawyer, a banker, a government institution, an insurance agent, an insurance company, homeowner, and a real estate professional.

In a further aspect, a computing system having a processor, communications subsystem and memory, for securing and performing a transaction may be provided. The computing system may be configured to receive, from a first party, a request to start the transaction, verify the identity and a role for the first party, and identify, from the request, a transaction type and parties to the transaction. The computer system may further be configured to start a workflow for the transaction based on the transaction type, send, based on the workflow, requests for information to the parties to the transaction, receive the information. and store the information in a blockchain for the transaction.

In some embodiments, the computing system may be configured to verify the identity based on a single sign on and a credential identifying a user and a device.

In some embodiments, the computing system may be configured to verify by: receiving confirmation of identity from an authorized party within the computing system, sending a message to the first party to verify a communications channel; and sending a certificate for a computing device being used by the first party to the first party for manual or automatic installation on the computing device.

In some embodiments wherein the transaction may require information, the information being populated from a self-sovereign identity stored in a block on the blockchain.

In some embodiments, the computing system may further be configured to ensure authorization for the transaction to proceed after verification.

In some embodiments, the computing system may further be configured to, once the workflow is completed, send a final agreement request to the first party and parties to the transaction; receive confirmation from the first party and the parties to the transaction that the transaction is completed; and store the completed transaction on the blockchain.

In some embodiments, the blockchain may be a private blockchain that is accessible through an application program interface on the computing system.

In a further aspect, a computer readable medium for storing instruction code for securing and performing a transaction may be provided. The instruction code, when executed by a processor of a computing system, may cause the computing system to receive, from a first party, a request to start the transaction; verify the identity and a role for the first party; and identify, from the request, a transaction type and parties to the transaction. The instruction code, when executed by a processor of a computing system, may further cause the computing system to start a workflow for the transaction based on the transaction type; send, based on the workflow, requests for information to the parties to the transaction; receive the information; and store the information in a blockchain for the transaction.

In accordance with the embodiments of the present disclosure, a blockchain based enterprise application for real estate transactions is provided. One purpose of a blockchain solution is to promote trust in large financial purchases. In particular, a real estate transaction is, in many cases, a person's single largest lifetime purchase.

Therefore, methods and systems for securing a transaction electronically utilizing an approach that is standardized for each deal allows for the deal to be processed in a secure, reviewable fashion. Specifically, embodiments of the present disclosure provide for a system in which each participant may be identified, and such identification may be stored securely in the system. This identification of each participant may be referred to as “Know Your Customer” (KYC), and can provide for identification verification and eligibility checking. The system ensures that each step of the process is captured digitally, and authenticated by validating participants.

Rules may be enumerated to ensure all mandatory documents are provided and approved by all relevant parties, trying to avoid fraud, honest mistakes and inexperienced participants that may forget various steps. The deal process accurately imports key listing elements for the property for which the deal revolves from such system directly. The workflow in these cases is transparent to all participating parties and is standardized. In this regard, deadlines for conditions, waiver conditions and timestamps for all components are valid electronically. The use of blockchain removes ambiguity, biases and hearsay in the real estate transaction.

Furthermore, as such system becomes more standardized, universal and electronic, opportunities exist for further automation and speeding up the process. Smart contracts and workflows ensure notifications whenever a participant updates a deal and requires someone else to participate. Notifications, reminders, warnings and expired conditions keep the process moving in a more automated and responsive way than current manual processes.

Each person involved in the transaction may have a Self Sovereign Identity (SSI), which can allow for sharing of specific information about that person when the person allows such information to be shared. The storing of such information in an SSI may help automate data entry by agents, buyers and or sellers when standard responses and conditions can be entered and approved.

The blockchain for transactions can be audited, ensuring fraud is reduced and buyers and sellers are better protected.

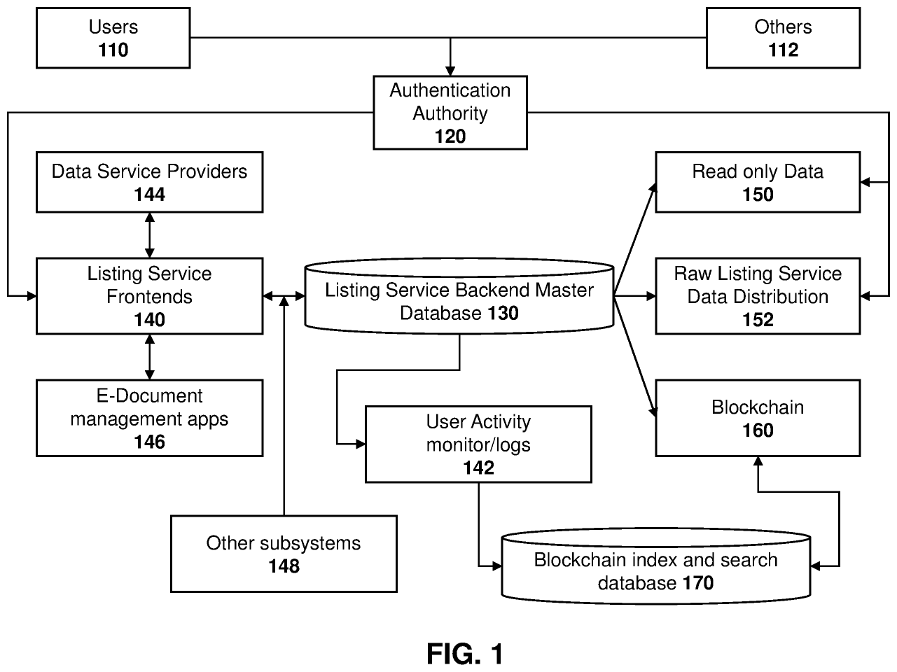

Reference is now made to FIG. 1, which shows a high level block diagram of a system for implementing the methods of the present disclosure. In particular, participants in the system including users 110, or other participants 112 attempt to access the system through an authentication authority 120 using digital identities, as described in more detail below.

Other participants 112 may include brokerages, other agents, system participants, authorized institutions or businesses, among others, to gain access to the system.

In accordance with embodiments of the present disclosure, an authentication authority 120 may authenticate users 110 or other participants 112. For example, in some cases, authentication authority may use identity and access management having various policies, processes and technology, which may in some cases be combined with a Single Sign On. In other embodiments, the authentication authority 120 may use a digital identity such as a self sovereign identity, which is a technology designed to improve the process of providing identity. In other embodiments, authentication authority may use other authentication mechanisms such as two factor authentication, application based authentication, short message service (SMS) based authentication, among other options. Other options for verification by the authentication authority 120 are possible, and the present disclosure is not limited to a particular method to authenticate users.

In this regard, authentication authority 120 may include an access credentialing dashboard for administrators to set required access credentials.

A listing service backend master database 130 is central to the design of the system of FIG. 1. Such database 130 provides a repository of listings and associated media that can be maintained with an integrated tool to add and edit elements within the database, and can log all changes to information in an audit blockchain database 170, as described below. In particular, as described herein, the blockchain database 170 provides an immutable history of listings over time, and is fed by the master database 130.

In some embodiments, database 130 may include business rules about the data in the database. Database 130 may therefore provide the ability to create and manage such business rules, publish new rules, manage revisions to rules, among other options. These rules can drive the adding of listings, editing and validation of listings, and can have an application program interface for such business rules.

Database 130 can have tightly integrated add and edit applications linked to the back end database that can be accessed by one or more frontend applications 140.

Database 130 may have a data integrity service, which scans the systems for violations of business rules. In some embodiments, machine learning or artificial intelligence may be used to scan input fields for geographic coordinates and other information that users have not entered or have entered improperly. Database 130 may track infractions by users. Further, database 130 may allow for workflow rules to be implemented to trigger notifications, billing or finance fees among other options.

Activities within database 130 may be logged in activity logs 142. For example, the logs may contain information about the users making the change, a change timestamp, a listing identifier, a field identifier, a previous value, a new value, among other information. Such logs may be stored in the blockchain database 170 in some embodiments. In particular, activity in the database 130 may be shared with the blockchain so that an immutable source of truth exists which tracks all changes and timestamps everything.

Databases 130 and/or 170 may allow for various search features. For example, in some embodiments, searches and notifications may be saved, which allow for a user to define search parameters. In some cases, machine learning or artificial intelligence can be used to provide suggestions for searching based on a past history of a user. The searching may further include an automated query or search match execution, which may provide real-time notifications such as through e-mail, SMS or push notifications, among other options, to a user interested in searching for real estate.

In some embodiments, historical records may be searched within database 130. Such historic searching may be limited to a subset of users 110 or other users 112.

In some embodiments, the listing service front end 140 may communicate with the database 130. A plurality of frontends 140 may exist. For example, system Application Program Interfaces (APIs) may be defined to allow users to select the tools that they feel help their business and a frontend can be written based on such tools and APIs. In some cases, integrated tools and pre-packaged frontends 140 may be provided to those users that are not able to create or customize their own frontends.

Frontend 140 may have tools to allow for the adding and editing of listings, or other information stored in database 130, as defined above.

In some cases, frontend 140 may be for users to search for listings within database 130, allowing for third parties to create such front ends.

In further cases, frontend 140 may consist of other tools, such as calculators, listing interfaces, among others. The present disclosure is not limited to any of the tools or frontends described above.

In order to accommodate the functionality of frontend 140, the frontend 140 may interface with data service providers 144 In some cases. examples of data service providers 144 may include public record providers, Land Registry and Assessment data providers, mapping providers, street photo providers, listing media, land-use information providers, neighborhood demographics providers, among others.

As indicated above, in some embodiments, such data service providers may provide data that can be automatically integrated into the frontend 140 to facilitate the adding, editing, or searching for records.

When data service providers 144 include mapping providers, such mapping capabilities may be used to provide school board boundaries, shopping and other services, postal code boundaries, or other map overlays. In some cases, mapping providers may provide interactive maps for property searching and tools. In some cases, maps may be downloadable for offline use and presentations.

The use of the data from data service providers 144 may be based on licensing and use restrictions in some cases.

In some cases, data service providers 144 may include new home suppliers, commercial property sales providers, leasing providers, among others, where such information would not typically be stored in database 130.

In some cases, data service providers 144 may store listing media if database 130 is not meant to store such media.

In some cases, data service providers 144 may include a buyer registry service where agents or other real estate professionals may register buyers they are working with. For example, if a Buyer Registration Agreement has been signed, such buyer has an agreement for representation, and the buyer registry service may inform other agents of such representation agreement.

Further, in some cases data service providers 144 may include associations that provide network authentication functions, “do not call” registries, anti-spam functions, anti-money laundering or other illegal financial activity monitoring functions, among other functionalities.

In some cases, electronic document management applications 146 may interface with the frontend 140. In this regard, a transaction can be started directly from a listing view with a single click, opening a wizard to auto populate required forms from listing data. Such forms can then be sent to all parties for signature using pre-programmed signature blocks in some cases.

For example, the electronic documents may include forms, contracts, among other documents, and in some cases be blockchain compliant in accordance with the embodiments of the present disclosure.

Other systems 148 may interact with frontends 140 and/or database 130. Such other systems may include communications systems, member and office rosters, permission assignments, accounts receivable services, products data services, electronic commerce services, among other systems.

For example, for communications services, users may access the system of FIG. 1 on a daily basis, making it a convenient location for announcements, news, communications and permanent information on service groupings, one time notifications, persistent notifications, articles, blog posts, pages with service information, links to third party services, push notifications, target communications for various groups of users, customized home pages, among other features could be provided by communications services within other systems 148.

Member profiles and management may also be done through other systems 148. For example, the member profile may allow a specific member to maintain a professional profile in the system, including photos, titles, contact information, social media links, bibliographic information, languages spoken, specialties, designations or other information about a member of the real estate system. For example, a member may include an agent.

Member management may also be maintained within other systems 148. For example, this may be used to support third party verification assistance to ensure that users are active members of the real estate board. Such member management may also be used for managing privileges of members and role definitions for such members.

Electronic commerce functionality may further be maintained through the other systems 148. This can facilitate the adding, editing or providing of information and the payment for doing such functions within the system of FIG. 1. E-commerce functionality may include payment gateways in some cases. Further, electronic commerce can also be a part of the blockchain database 170 to allow access to the data held within the blockchain instead of or in addition to data held within backend database 130.

Other systems 148 may further include help desk functionality, which may be provided by employees of the system creator or administrator, or the functionality may be provided by machine intelligence based on a knowledge base.

Rather than, or in addition to, a frontend 140, an authenticated user may only be allowed to have certain read only data from block 150. In this regard, read only data block 150 may interface with database 130 and obtain the data, which could then be provided back to user 110 or other users 112. Again, an API may be created to allow for data access within database 130.

Further, an authenticated user may only be allowed to have certain read only data from blockchain component 160, which may interface with database 170 and obtain the data. Such data could then be provided back to user 110 or other users 112. Again, an API may be created to allow for data access within database 170.

Further, in some cases third parties may contract to receive raw listing service data, and this may be done through a distribution service 152 which may interface with database 130 through APIs.

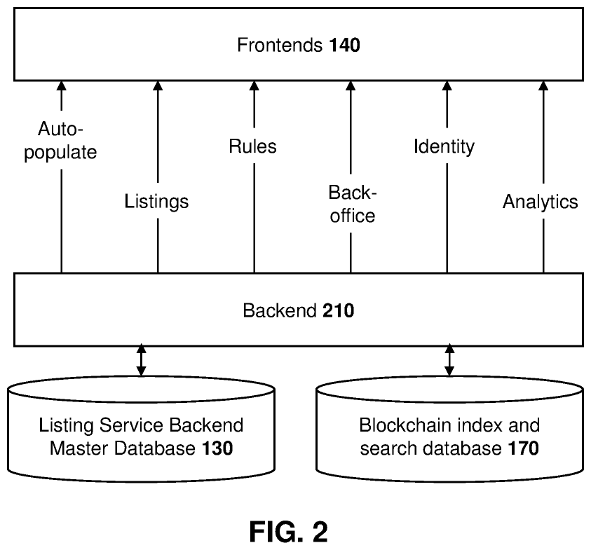

With regard to APIs, reference is now made to FIG. 2. APIs encapsulate a backend 210 and provide data to frontends 140, as well as other integrations. The use of an appropriate, secure microservices environment to fulfill API requests and to better secure and control data is therefore provided with the embodiments of the present disclosure.

The example of FIG. 2 provides several APIs. However, these are not limiting, and other APIs may similarly be provided.

In particular, an auto-populate or pre-population API shown in FIG. 2 provides basic information about a property to fill out new listings. This API may be used to populate external add or edit functionality and electronics forms application programs with information needed to create an initial listing, for example.

A listings API allows access to active listings. Such API may be used by a user or party designated by a user to access information on a listing by listing basis. The API may be used to obtain information for resources such as listings, historical transactions, media, member resources, office resources, open house resources, properties resources, teams resources, rules resources, team members resources, among others.

A rules API provides data rules that are used in the adding or editing process for listings. The API may, for example, be used by external add or edit programs to check listings before submissions.

A back-office API provides listing information that is consumed by broker operations systems. This API may be used by brokerages to gather information about closings to drive a compensation processes.

An identity API may be used to provide data with regard to the digital identity of participants in the system.

An analytics API may be used to provide analytics with regard to the use of the system, for example. The API may, for example, have the ability to support broker installed analytics packages and published data packages.

Blockchain APIs may be used to provide access to data within a blockchain database 170.

Other APIs can be further added. Also, underutilized APIs may be decommissioned. Thus, APIs may need to be instrumented to allow for analysis of their performance in the market over time.

The use of APIs allows for the protection of data integrity, and may be combined with digital rights management to ensure that data integrity is maintained within the system of FIG. 1.

Referring to FIG. 1, the system in this figure includes a blockchain component 160. Blockchain technology is used, for example, for identity and access management and collecting transaction state information from electronic document management applications.

The blockchain component 160 is described in more detail below, but may include identity blocks for corporations, participants, users, transactions, among other components. The use of blockchain facilitates anti-money laundering environments, provides proof of completion of tasks in a non repudiable function, and allows for rule-based transactions to be completed in a more automated fashion.

The blockchain component 160 interfaces with blockchain database 170.

The modular, component architecture of FIG. 1 allows a system provider to deliver a favorable experience to all users across the entire system. Due to the modular nature, various components can be upgraded or replaced as needed. The components work together to deliver a modern experience that takes advantage of emerging technologies.

In the system of FIG. 1, artificial intelligence and machine learning may be used to facilitate transactions. In particular, automated matching of listings in a saved search environment can be improved with machine learning. Typical saved searches use user supplied listing parameters such as rooms, price, locations, among other data points, to drive searches. With machine learning inference models applied to this area, matches can be created based on demographics, income and lifestyle information about the consumer in some cases. Thus, machine learning models can be used to learn based on client's past searches for suggesting additional properties, locations, amenities, or other features of interest that could be useful to such consumer.

Further, machine learning inference models can reduce the effort needed to encode descriptive information about images or to comply with business rules related to images. In this regard, value added services can be created to generate text descriptions for user images as they are submitted. The technology can be used to scan and identify contents of images. This can further be used to provide for accessibility to those with disabilities.

In some cases, machine learning may be used in a call centre to reduce resources dedicated to walking users through frequently requested procedures.

Machine learning technologies can be useful in ensuring data integrity by scanning text fields in listings.

The system of FIG. 1 can be further used for comprehensive reporting to a variety of audiences. Reported topics could include market conditions, projections, historical trends, among others, and could be customized and flexible.

Further, the system of FIG. 1 could be subject to syndication. In particular, distributing active listings is important to exposing a broker's inventory to the widest possible customer audience. Consumers visit websites operated by brokers, agents and third parties. The system of FIG. 1 ensures that the same information is sent to the operators of each of these websites by supporting feeds. Feeds are an outbound distribution mechanism supported by various standards.

Utilizing the system of FIG. 1, methods and systems are provided that facilitate a digital real estate transaction. A digital real estate transaction may include buying, selling, leasing, or renting of real property. The system is applied utilizing a tokenized blockchain solution. In accordance with the embodiments of the present disclosure, real property has various forms, including, but not limited to, residential property, commercial property, business brokerage services, among others. Further, transactions typically are initiated through a system such as a multiple listing service frontend and backend that is serviced through the tokenized blockchain solutions.

One factor within the system includes blockchain based digital identities, and more specifically identity blocks. As described below, these form a significant component of the embodiments of the present disclosure and provide a high level of security, confidence, integrity, as well as participant and event tracking certainty while facilitating the transaction through the tokenized blockchain solution.

Specifically common blockchains solutions come in a number of different base configurations and approaches. First, there are public and private blockchains. Cryptocurrency, for example, is generally denoted by its public, no central control mechanism and thousands or millions of nodes spread and shared over a network of independent computers to the public. These public computers are paid to participate, generally in Bitcoin or cryptocurrency and they are part of the cost of using the system. Miners are also paid to be part of the system used to solve complex computing algorithms in a race to provide the answer to be used to validate the authenticity of the block being stored on the blockchain and then copied to all peer nodes. The authenticity is then reviewed by other peer nodes on the network so that no single node has full authority or can change their copy of the data without triggering alerts of tampering by the other nodes. This distributed model provides an incredible level of independent security and self regulation. Once a participant has a digital key and software on their computing device, they can participate in the network.

Conversely, private blockchains generally provide what businesses want from their blockchain offerings such as immutability, which is the audit portion of a blockchain that forms the basis of why this is an important difference between a database and a blockchain. Immutability is a historical audit Ledger of a transaction that has been committed to the blockchain. It relies on blocks committed before it and after it to ensure no tampering or changes of taking place through the encryption keys. Immutability means that once a block is written to the block chain it is there forever. If you need to make a change to that block you need to create another block that amends the changed and is clear to those involved in the transaction that the change was made. When discussing those involved, private blockchains provide a layer of permission based access. Unlike a public blockchain, in a private blockchain not everyone gets to see all blocks in their contents. Businesses may use this concept to share the correct information with the correct entities in the blockchain ecosystem. As everything is read-only, access permission is generally whether you can see the contents of a block or not. Secondly, new blocks can be written as part of the blockchain group or blocks. Typically, it is only the system that can write new blocks, and individual users may have credentials to ask the system to write new blocks on their behalf.

In one embodiment, at least three distinct blockchains are provided in the system, with database structures that support rapid indexing and searching of the blockchains. A Real Estate Standards Organization, R.E.S.O. standard may be used, which may be updatable to future standards as they become available. Further, the system may provide a data dictionary and event audit blockchain. For example, the audit blockchain may use Hyperledger Fabric as a base platform. An SSI blockchain, such as Hyperledger Indy with Hyperledger Aries running on top of Hyperledger Ursa, may be used to implement SSI. A third blockchain may exist for the deal blockchain.

The above may exist in one network and, as a private blockchain have a series of blocks defined in the workflow for the deal process according to the blockchain template chosen. These will all be stored on a single blockchain indexed into a database 170. Such database 170 may be rebuilt if ever corrupted by re-reading the blockchain from start node to end node.

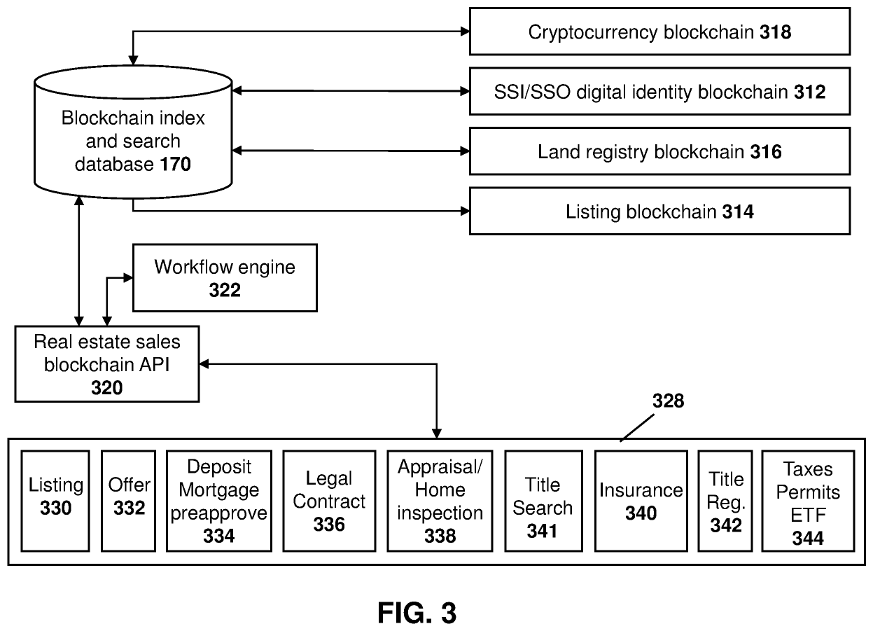

Reference is now made to FIG. 3, which shows a block diagram of the tokenized blockchain solution. Central to the tokenized blockchain solution is a blockchain index and search database 170, which allows the searching of various blockchains for specific information. Database 170 further stores the blockchains and may control access to who has rights to view and/or add to blocks (e.g. to edit blocks). Such access rights control who has access to data within the database 170 and may be a paid or subscription type service in some cases.

Various blockchains having different functional blocks may exist within the present embodiments. In the example of FIG. 3, a digital identity blockchain 312 may provide storage for identity cryptographic keys for the participants in the system. In particular, blockchain based digital identities may be used for the authentication and credentialing utilized within the system to allow and track all users, their usage activity and that of any and all associated service providers. Such service providers may include approved vendors, suppliers, brokerages, among others. In some cases, the identity public key may be stored on the SSI blockchain, while the private key and all of the user's information is stored in their SSI wallet on a personal device such as their mobile phone. In this regard, a user's personal information, credentials/certificates and preferences may not be stored centrally and may be permission based for the user to share or not.

The system monitors users' activities to authenticate and allow access to various related facilities available through the service and backend system, as well as monitor all activity and events throughout the process, from initiation to completion. This provides the basis of access and continuity through the system.

Digital identities form a verifiable source for tracking purchases, payments, e-transfers and any other transfer of funds, content or data throughout the system. In one embodiment, such digital identity maybe a single-sign-on (SSO) digital identity backed by two factor verification on initial signup, and device installed certificate for authentication. A digital identity may map to a role within the system. Thus, a user may have access to certain screens, fields on a screen, have read only access, right access, or no access to certain fields, and the user may be granted permission to another user to view or edit various information. As used with blockchain, the editing of information means the creation of an amended block on a blockchain.

In some cases, all users using the systems of the present disclosure may be vetted. In particular, such vetting could use Electronic Identity Verification (eIDV). For example, Realtors can get onto the system via SSO, but as participants are invited to the deal, validation of who they are may be employed. Consumers can be validated through eIDV solutions. Professionals may have to be validated through other means in some cases.

Expanding on this, a digital token may in some embodiments be created for the system. Conceptually for the Blockchain to have an immutable record, it may be assumed that all participants involved in the transaction are validated/verified in some manner to assure they are who they claim to be and have a bona-fide right to be involved in the transaction.

In some cases, deal participants may be invited in by the listing agent, but may not be formally vetted with any 3rd party application. Realtors are vetted via SSO

For the buyer/seller transacting digitally, verification may require a form of electronic digital identification solution that can be relied upon, stored and recalled if needed later.

In some cases, once the buyer/sellers ID is confirmed, for example through a multi factor authentication solution, then a digital ID (token) could be created and associated to the transaction record(s). Such records may include the purchase and sales agreement (PSA), mortgage application, title, among others, which may also be stored on the blockchain.

Digital identity blockchain 312 may therefore store various types of identities. Each identity block within the identity blockchain 312 may be provided with an encrypted identity key, which may consist of a token or hash. All connected participants may be specifically identified and associated within a particular block. Any authorized service related participants to the real estate transaction may be provided access when identification and credentialing criteria have been met and secured. Further, the system may include transactional and payment related information and processes, and be accessible for government, anti-money laundering or other purposes.

In particular, digital identity blockchain 312 may include consumer personal identity block cryptographic keys, which may include user-given permission based access to various information about a consumer including their legal name, current address, contact information, identification documentation, identification of the lawyer the consumer is using, identification of a mortgage broker the consumer is using, among other such information.

In some embodiments, digital identity blockchain 312 may include real estate brokerage identity blocks. For example, such identity blocks may include information about the real estate brokerage, contact information, a broker of record, associated office identity blocks, managers, among other such information.

In some embodiments, digital identity blockchain 312 may include real estate salesperson identity blocks, which may include information about various real estate salespersons. For example, such identity block may include the salesperson's name, title, contact information, real estate board identifier, brokerage in office identifier, representation identifier indicating whether the agent represents the buyer or seller in the transaction, among other information.

In some embodiments, digital identity blockchain 312 may include corporate identity blocks. For example, information in corporate identity blocks may include corporate representative identity blogs, franchisors, stakeholders, among other such information.

In some embodiments, digital identity blockchain 312 may include government or institutional identity blocks. These may include identity blocks for taxation authorities, municipal authorities, state or provincial authorities, federal authorities, government insurance authorities, Land Registry authorities, among other such authorities.

In some embodiments, digital identity blockchain 312 may include blocks for government or institutional representatives. These may include an identifier for the government or institutional body, the name of the representative, the position of the representative, contact information for the representative, among other such information.

In some embodiments, digital identity blockchain 312 may include service provider identity blocks. For example, service providers may include lawyers, home inspectors, mortgage brokers, financial institutions, transaction facilitators, appraisers, insurance companies and representative information from such service providers. The information in these blocks may include institutional information such as name, address, contact information among other such information. The information further may include representative information, including the name of the representative, a provider identifier for the service provider, contact information, among other such information.

In some embodiments, digital identity blockchain 312 may include an identity for a real property. However, such identity may also be stored on a listing blockchain 314. For example, blockchain may have information about the listing service listing and related information, transactional and conveyance information, inspection reports, environmental information, insurance information, legal property details, ownership, address and other identifying information, Street View and other photos, surveys, permits and work orders, among other information about the real property.

In some embodiments, the digital identities within digital identity blockchain 312 are self-sovereign identities (SSI). This means that actors within the system would have control over identifying information and what identifying information is shared with others. As such, an actor within the system would control access to those credentials and have the ability to update data within the identity. In general, trust may be established with the SSI by one party presenting credentials to another trusted party. For example, a brokerage may verify trust for its agents. The brokerage may be a trusted player in the system as it has been verified by other means in one example.

Some cases, the digital identities within digital identity blockchain 312 maybe single sign-on (SSO). For example, this may be based on a certificate exchanged between the identity provider and the service provider. The certificate can be used to sign information that is being sent from the identity provider to the service provider so that the service provider knows that it is coming from a trusted source.

Using the digital identities, other blockchains may exist within the system, including Land Registry blockchain 316 which may store Land Registry information, cryptocurrency blockchains 318 which may be used for cryptocurrency based payment systems, among others.

Further, a real estate sales blockchain API 320 may exist for facilitation of transaction. Such API 320 may use the APIs described above with regard to FIG. 1.

Other APIs may exist and be provided to 3rd parties (e.g. lender, lawyer, appraiser, title insurance etc.) so that they can automatically push content back to the blockchain database 170. For example, once the legal contract is complete, the lawyer can leverage an issued API from the system of FIG. 3 to upload any relevant documentation.

Other options and examples for APIs to interact with database 170 are possible.

Further, a workflow engine 322, as described below, may create a workflow for a typical transaction. this may allow for notification of parties that they are required to complete a step in a transaction, determining that a transaction step has been completed, among other workflow items.

Results of a transaction may be listed in a block 328 for a transaction blockchain, and can take information from the various blockchains 312, 314, 316 and 318, as well as information from various service providers. Such transaction information may include a listing 330, an offer 332, a deposit mortgage pre-approval 334, a legal contract 336, an appraisal or home inspection 338, a title search 340, insurance 341, a title registration 342, taxes, permits, electronic fund transfers (EFT) 344, among other information.

However, as indicated above, in some cases only three blockchains may exist as part of the system, namely an identity blockchain, a transaction blockchain, and an audit blockchain. Thus, the embodiment of FIG. 3 may be modified to have information stored outside of the blockchain, for example for listing, land registry, etc.

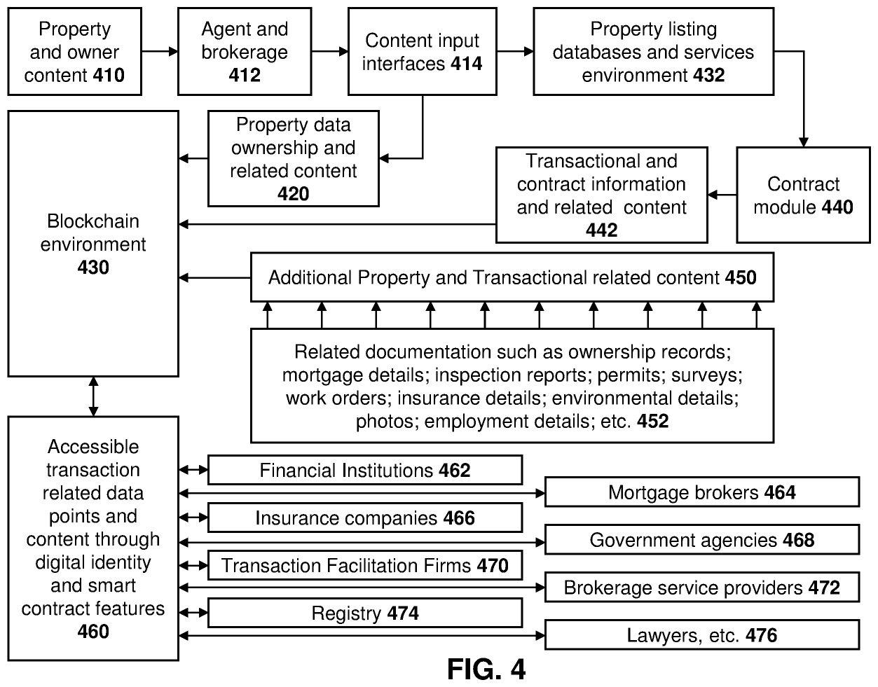

Using such blockchain structure, an example of data capture and flow is shown with regard to FIG. 4. In the example of FIG. 4, property and owner content, shown with block 410 is provided to an agent (or other real estate professional) and brokerage at block 412. The agent and brokerage may provide, using content input interfaces at block 414, the property ownership and related content, as shown at block 420, to a block chain environment 430. Blockchain environment 430 may in some embodiments comprise the blockchain component 160 and blockchain database 170 from FIG. 1, along with various APIs.

Further, information from property listing databases and services environments, shown at block 432, may be provided to a contract module 440. The contract module may provide transactional and contract information, and related content, as shown at block 442, into the blockchain environment 430.

Further, additional property and transactional related content, shown at block 450, may also be provided to the blockchain environment 430. Such additional property and transactional related content may come from various service providers, shown in the example of FIG. 4 at block 452. For example, service providers may provide information such as ownership records, mortgage details, inspection reports, permits, surveys, work orders, insurance details, environmental details, photos, employment details, among other information.

The information may be provided from accessible transaction related data points and content, through digital identity and smart contract features, as shown at block 460. This information may be provided from various service providers including financial institutions 462, mortgage brokers 464, insurance companies 466, transaction facilitation firms 470, brokerage service providers 472, registry providers 474, lawyers or other service providers 476, among others.

Further, the various parties and service providers, such as financial institutions 462, mortgage brokers 464, insurance companies 466, transaction facilitation firms 470, brokerage service providers 472, registry providers 474, lawyers or other service providers 476, among others, may load completed documentation, etc., to the blockchain environment 430, once complete.

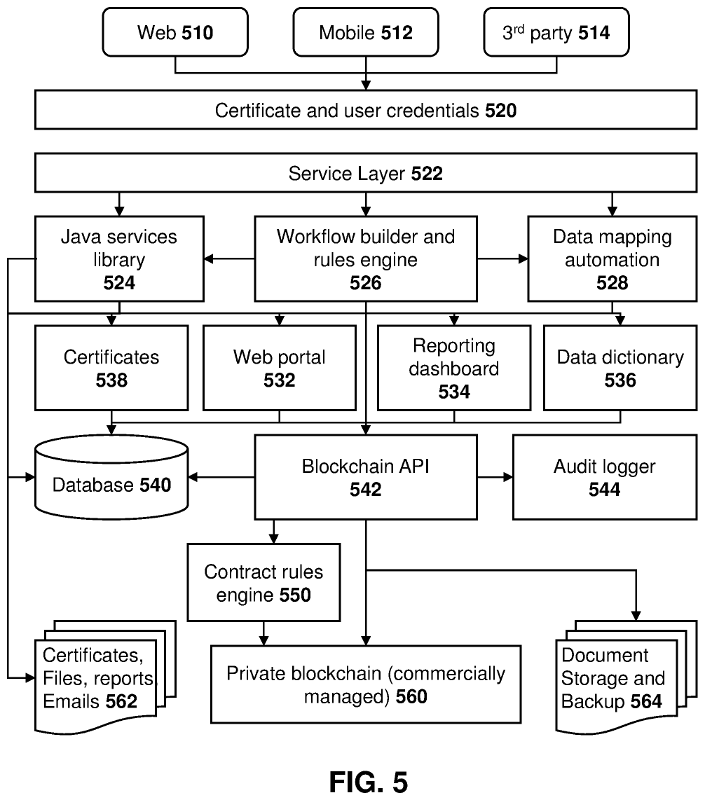

This flow may be implemented using various stacked layers. Reference is now made to FIG. 5.

In the embodiment of FIG. 5, a presentation layer consists of a web-based interface 510 and a mobile based interface 512. Such interfaces provide access to core application services. Various parties within the system, including agents, brokerages, buyers, sellers, lawyers, banks, appraisers, among others, may access system components using such web interface 510 or mobile interface 512 to access mobile or web responsive applications or use their own application by calling specific API services.

At the same level as the presentation layer, a third party interface layer 514 may provide access for business to business (B2B) services, third parties and content providers. Examples include land registries, appraisers, bankers, lawyers, among others. Such interface layer 514 may allow these parties to access and provide authorization and data to the system.

Others using such interface layer 514 may be content acquirers and may have a subscription or pay-per-use access to data that is extracted from the system.

A security layer 520 may used for certificates and user credentials. For example, security layer 520 may use the Open Authorization 2.0 (OAuth 2.0) resource access system in some cases. Every device and every partner that would like to access the services must go through this security layer 520. For example, frontend interfaces may have access to the services for their applications, in some cases by using a single certificate and partner credentials.

In some cases security layer 520 may use single sign on for agents, along with self-sovereign identity (SSI) and the authenticating blockchain. In SSI, the certificates (encrypted credentials-cryptographic public/private keys) are on a user's mobile phone or other electronic device.

When signing up for the first time for the system, checks may be performed to determine whether a user is already a subscriber to other entities recognized by the system. For example, an agent may belong to a brokerage who is already part of the system, or a customer may have been provided a single sign-on identity by a brokerages. If such SSO identity exists with an approved entity, the single sign-on identity for such other approved entity may then be used to start the process.

In some cases, this first sign on may require that the user's identity be confirmed, for example through an e-mail or short message service (SMS) message, where a code may be sent to the user. In other cases, an authenticator application associated with a mobile device or computer may be used. Other options for verification are also possible.

Once the user is confirmed, a certificate that is specific to the device the user is using may be sent to the user in some cases. For example, if the user is using both a mobile device and a computer, such user may get two certificates. For logging in verification, basic information may be stored, including, but not limited to, the IP address of the request, a cookie that is registered, information about an operating system, version, device type, Media Access Control (MAC) address, among other such information.

Typically, when receiving a certificate file, a user may only need to click on the certificate and it will prompt them to install it on their browser or phone certificate manager.

Thereafter, using their SSO credentials, their certificate, and the role or credentials that have been assigned by the system that referred them, a user will be able to use the system securely and access is locked down to a user-device level.

If a user switches devices or if a new certificate needs to be issued, the user may then have to log in with their SSO credentials and a new certificate may be sent to their authorized e-mail or SMS address.

In some cases, when sending a certificate, such certificate may be password protected to enable the user to further protect themselves from the certificate being misused.

A user may also control a self sovereign identity (SSI). SSI data is data that a user wants to save about themselves such as their name, contact information, brokers license, drivers license, passport, bank information for EFT, escrow accounts, preferences, and canned answers to repeated questions. It works similarly to a browser that remembers data that may help you fill out forms faster. However, with SSI, data is kept on the users' own mobile device and is encrypted with a user's certificate (private certificate on their device and a public certificate kept on the SSI blockchain). As such, the data can only be unencrypted with the user's permission, either to another user or to a process such as one closing a real estate deal. SSI data may be permissioned on a case-by-case basis or may generally be permissioned to be always available as part of a deal transaction, among other situations.

SSI data is useful when using smart contracts, for example with the systems of the present disclosure, since it may automate the process when certain checks and balances are needed in a deal. For example, a check may be needed to determine whether the sellers and buyers brokers' licenses are up to date, whether there is a conflict of interest if the brokers are from the same brokerage, lawyers are from the same law firm, among other checks.

In some cases, SSI data may be saved over time. For example, as information is provided during a transaction, a request on whether such information should be saved to a user's SSI may be made, and if the user approves then such information may be stored for future use. In some situations, a user may populate some of the information when first creating their account.

Referring again to FIG. 5, a service layer 522 is shown. Such service layer 522 allows the processing of web service transactions. For example, the processing may occur using hypertext transfer protocol secure (https) transactions, in some cases in JavaScript Object Notation (JSON) or extensible Markup Language (XML) formats. The services layer can take advantage of role, credential and certificate security authorizations, and can determine if a request has the correct credentials to return the data. Services may be provided at the services layer 522 with memory-based rules, schema and processing.

In one embodiment, services layer utilizes “stub” services, which are the contract between the frontend APIs and the backend, so that both sides do not wait for each other to be completed before testing their respective processes. By using stubs, all positive and negative test cases may be tested to see how a system handles these cases. For example, testing and regression testing tools may be used to run a battery of tests against any updated code to validate that the results provided are the expected results.

Schemas for the services layer 522 may be kept in a database 540, which in some cases may be blockchain database 170, but may also be published to a file. This allows the self documentation of services with their inputs and outputs with example stub data by directly extracting information from the database and publishing the results.

Services layer 522 can call Java class components directly from a Java services library 524, or may call a rules engine 526 to call a workflow that may include several micro-services and mixed class calls with database and blockchain updates.

Rules engine 526 comprises an orchestration engine for many reusable Java components that make up a development library. In particular, rules engine 526 may communicate with a Java services library 524 and with a data mapping automation function 528. Further, the rules engine 526 may utilize a data dictionary 536.

Data mapping automation 528 may provide a graphical interface for creating rule sets for particular functionality. An administrator or user with central security access may manage rules, including field level access and logging and monitoring the access as requests are made.

The mapping automation 528 allows the addition of new ingestion flows for data. For example, services such as legal contracts, banking and cryptocurrency, selling of data services in real time, appraisals, listings, offers, deposits, title insurance, title look ups, home insurance quotes, home insurance policies, among others may have a rule set that allows for the appropriate parties within a transaction to complete a workflow.

In some embodiments, data mapping automation 528 may be a graphical user interface (GUI) system designed for rapid development of custom data mapping requirements. It therefore creates the ability for clients to manage and create their own services when the tool is being used and working with APIs for their various presentation layers.

Further, in some embodiments, an abstraction layer between a set of core microservices, custom database queries, API managed blockchain and generating the format and nomenclature required by a client for their unique presentation layers may exist.

In some embodiments, the data mapping automation block 528 allows for synchronous or asynchronous data service requests from a presentation layer to a rules engine 526.

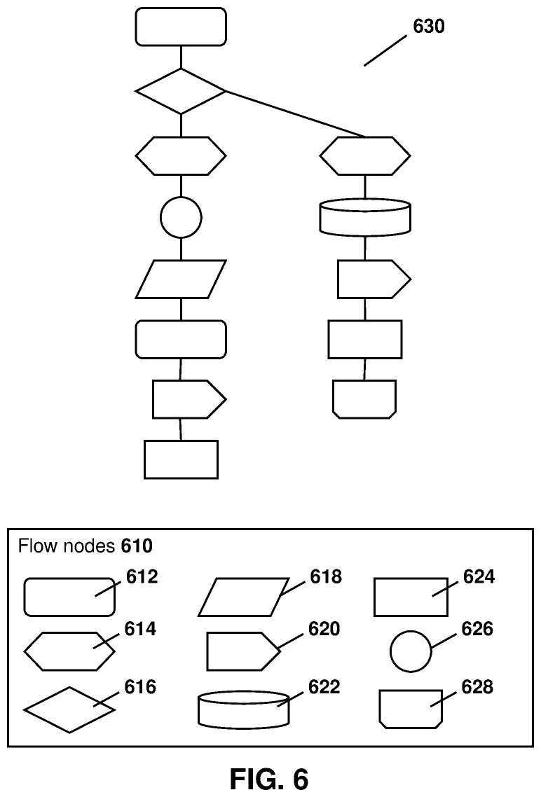

For example, the rules engine and the data mapping automation block 528 may be a graphical user interface drag and drop data mapping tool. Reference is now made to FIG. 6. In the embodiment of FIG. 6, various flow nodes 610 may exist that allow a user to create a rule for workflow.

In particular, node 612 may be a start process or sub process node. A start process node may be automatically generated for a new flow diagram. It is the starting point, and reference point of other flow diagrams that want to link to this as a sub process. Such node 612 only has one connection point, which is the out point towards the next element. As a subprocess element, the node may start a new flow diagram that is linked to by another flow diagram. Therefore, when linking with a subprocess, the workflow goes to a new flow diagram, executes the logic of that new diagram, and then, when complete, returns to the node that called the subprocess.

Node 614 is a setter node and is used to perform simple rules based on data in the process flow. Such data may be input as parameters, for example from a database or by cross checking and reading values. The node then has the ability to change fields in a single or array of occurrences.

Node 616 is a decision node and can make a navigational decision based on whether the data takes a true or false path.

Node 618 is a file input node and is used to ingest a customer file for example in a comma separated values (CSV) or other delimited file format, for the purpose of capturing fields and mapping them to an output object that can be used in a program or database.

Node 620 is a data mapper which may take data in a session and reformat it for a final output through return data steps. Such flow object may carry rules of the data from other steps and decide if fields are being added, changed, removed, among other functionalities.

Node 622 is a flow object that can connect to a customer database defined for the project and allow a query to be run and the results of the query to be added to the data payload, or a response to selection may be returned for insertion, updating or deleting with a count of how many records are affected.

Node 624 is for the return of response data. In one embodiment, the return of the response data may be based on an Ajax call. However other options are possible.

Node 626 signifies a rules engine transaction that runs a synchronous call, passing any mapped parameters from input parameters or data captured from a database or the rules engine in a session object. A metadata editor for this node enables real-time calls to get sample responses and test the input parameters to get the format of the response, which may be mapped to a session object for the data return.

Node 628 represents a blockchain transaction that has properties to read or write to the blockchain, along with the data model that will be loaded or retrieved, including documents.

In one embodiment, the flow node 610 may be dragged and dropped onto a flow chart and metadata added to each flow node. For example, one flow chart is shown as flow chart 630 in the example of FIG. 6.

In this way, a workflow for a particular process or subprocess of a real estate transaction can be defined. For example, contracting steps utilizing digital or electronic contracts can have preconditions for a first step before the next step is executed. The party that needs to execute a step could be defined and notifications provided when that step comes due.

Referring again to FIG. 5, a web portal 532 may be a destination for a user application needs within a portal. The web portal can be used to maintain security roles and credentials, send communication messages to audiences through a messaging centre, store broadcast messages, provide reporting (using a reporting dashboard 534), among other functionality.

Certificates may be stored in a certificate store 538.

In accordance with the embodiment of FIG. 5, a blockchain API 542 may be used to access a private blockchain 560. The blockchain system of FIG. 5 is configured to manage documents, upload and view key forms, manage the smart-contracts for blockchains and blockchain templates. In some cases, service providers may need a permission based download functionality. For example, banks may need a sold MLS copy or other documents for the client to be uploaded into their own banking systems. Other service providers may need similar access.

In particular, the blockchain API 542 may be used to set a contract rules engine which may use rules built at rules engine 526 to manage the flow for a contract. Such flow may further interact with the private blockchain 560.

API 542 may be used to upload documents into a block, for example according to rules. The API may consist of a browser with a web application running thereon, which may be used to locate files and upload them to a block within the block chain.

Once the document is uploaded and stored in a secured file repository (the blockchain), it has a unique digital token generated based on the BLOB data and that key is kept with the document to ensure that there is no tampering of the document. Thereafter, the document is only accessed within the system.

Those with authorization may visually view the blockchain and the documents therein.

For each contract within the contract rules engine 550, various rules and steps can be managed for each block in the blockchain. For example, steps may include capturing digital signatures, uploading documents, getting approval on the documents, among other steps to validate a contract.

In some cases, each block may further provide updates for templates of what users have access to and the various steps and processes of what access they have and can see. For example, a block may include steps that certain documents can cause notifications to issue, can require acknowledgements, can allow the security of the user to delete a notification (or the notification/read status and acknowledgement are a permanent record of the workflow. The document, once uploaded to the blockchain, is read only based on permission and credentials to be able to view the document. The document is now immutable and permanently part of the history of the blockchain. In the case of a mistake for the document uploaded or a revision-a new block will be created and the new document uploaded, but the original document is always there along with its chronology and original document. A newer version can be uploaded to be the current version and may require approval from others in the deal, among other functionality.

In some cases, certificates, files, reports on emails may be stored outside of the blockchain, shown with repository 562. Further, document storage and backup 564 may be used for documents that are being edited.

The audit logger 544 may audit all transactions, accesses and updates for listings, deals in any other log event for long term audit and fraud prevention.

The blockchain 560 uses SSI, as described above, which comprises set of private encrypted data for each participant in the real estate transaction deal. Such participants may choose to enter their data into the system to execute smart contracts quickly and efficiently in the deal process.

The deal blockchain houses all key data components that allows for a trusted neutral “single source of truth” for documents, data, transactions, records, among other information, for the purpose of closing a real estate transaction. The base configuration is infinitely extensible and uses rules based smart contracts and workflows.

Utilizing the system of FIGS. 1 to 5, various use cases and roles are possible.

A broker/agent administrator in the system may define and enter companies and may define the main company administrator. Such administrator may then define more company locations and manage users on behalf of their company and their clients.

A system/blockchain administrator may build and manage blockchain types, contract types, smart contracts and rules that implement them. A blockchain administrator may further manage the data dictionary and exceptions.

A system administrator may maintain system parameters, where required, to change the behavior of a system.

The system administrator may further monitor system performance and adjust hardware requirements as needed.

The system administrator may be responsible for proper document, database and blockchain backups, and may schedule periodic disaster recovery tests.

A system administrator may schedule and deploy code changes. Further, the system administrator may monitor application and server logs for anomalies. In this regard, the system administrator may review system performance monitors for any alerts and performance concerns, and identify and manage any long running database queries, application response times and blockchain write speeds for any abnormalities.

A further role may comprise the multiple listing service. Such role may provide an SSO master interface to validate user IDs against a consolidated authorization process. Further, Realm may then send standardized data from MLS transactions, such as new listings, modifications to listings, or delistings, and information about properties, agents, locations, for entry into the blockchain audit logger and event repository.

The Realm role may further handoff MLS data for the start of a blockchain deal transaction, for offers, closing deals, among other transaction types.

A selling brokerage role may use their SSO sign-in to gain access to the deal blockchain system in order to view their available MLS listings and create their own deals. The selling brokerage can then define their deal participants, and the role and access capabilities to various steps and notifications in the deal process. A selling brokerage can import a list of participants: clients, partners such as lawyers, appraisers, contractors, decorators, stagers, etc., into the customer relationship management tool for the agency. This may be a mass import transaction in some cases. In other cases, agents can enter their own participants one by one.

Selling agents may further have various roles and privileges. A selling agent may make changes to a listing. However, in this case audit details for changes would still come to the blockchain.

A selling agent may further initiate a deal transaction in a blockchain and import the MLS listing for the subject property. The selling agent can add participants to the deal either up front or as they become known.

A selling agent may further add their own self sovereign identity attributes for workflow automation and the permissions for the current deal and future deals until such permissions change.

A selling agent may upload any relevant documents to the deal process, such the offer, conditions, waivers, property surveys, inspections, property taxes paid, among other such information.

A selling agent may monitor the deal to ensure workflow is moving, be alerted when things get stalled for too long, among other factors. In some cases, the selling agent may send broadcast messages to one or more of the deal participants. Further, in some cases the selling agent may set up and execute a system parameter based auto broadcast message, such as when delay thresholds have been met, acknowledgements need to be provided, among other threshold characteristics.

The selling agent may act on behalf of the sellers for certain parts of the transactions, especially if the sellers are not comfortable with computers. In such case, the sellers still need to be identified electronically, but may just be required to digitally sign, approve and/or waive conditions.

The selling agent may request a consensus close to a deal when all components have been completed, and in this case the smart contract may be able to auto close the transaction after a threshold amount of time.

Thus, a selling agent may effectively manage all aspects of their deal and have tools to move the deal along and/or manually upload information and documents on behalf of various stakeholders if such stakeholders are not comfortable with the blockchain system of the present disclosure.

A buyer brokerage role may have the same privileges and obligations as that of a seller brokerage role. In this case, the buyer brokerage acts on behalf of the buyer's agent if the buyer's agent is not able to perform certain functions in their capacity. All updates may be logged with the agent that is assigned to perform the task.

A buyer agent role will take care of all aspects of the transaction related to the buyer, including helping the buyer to meet their conditions of the blockchain transaction. The buyer agent may be capable of messaging their clients, the sellers agent or brokerage, or other permitted contact for the deal. Generally, contact with the buyer or seller will only be done through their respective agent.

A buyer agent may invite their client to sign up for the deal application.

The buyer's agent may also enter the buyer's contact details and initiate the sign up and registration within the deal. For example, the system may require a legal name, contact information such as an e-mail address, mobile phone numbers if available, among other such information.

The role of a seller may be to first sign up in the system using their pre-established SSO sign-in from the agent authority, the system will also ask for a 2-factor authentication: for example through e-mail or a phone text request to confirm their e-mail and phone number. If the phone or e-mail is already registered then the seller may be requested to reconfirm their account user identification and password and check the current SSO credentials.

If any of these verifications fail, the seller may request support to determine why their SSO credentials are not enabling access to the deal application.

Once a seller has securely logged-in with SSO, they can provide the requested information for the blockchain. Some of the needed information may be available immediately at the start of the transaction, and some may become available during the transaction.

A buyer would have similar rules to the seller with different requirements to be provided for their part of the deal.

Many real estate systems have a know your client (KYC) requirement which requires government identification be verified. In this regard, one of the services that can be included in the system of FIGS. 1 to 5 can be to have a third party validate an identification and corroborate the identity ensure that the party to the transaction is who they say they are. Such third party may, for example, be a notary, lawyer, banker, or approved third party service in some cases. The agents also perform this Know Your Client (KYC) step as they engage their clients (buyer or seller) as part of their due diligence steps. These forms for KYC/FINTRAC can also be uploaded in the deal process.

The buyer or seller may upload their identification digitally to the blockchain and the third party may be the only ones with access to that identification and can verify the identity.

If the identification must be shown to a local party in person, then that local party may be part of the transaction to ensure that such local party is who they say they are. For example, lawyers or notaries may be part of the system, and already identified within the system.

A banker may further be part of the system. The banker may be required to validate a buyer's identity, provide mortgage pre-approval/approval documents, confirm escrow transfer of funds, waive or confirm mortgage insurance requirements, among other roles.

A government insurance company may also be part of the transaction. For example, in Canada, the Canadian Mortgage and Housing Corporation (CMHC) may provide insurance on non-conventional mortgages. In some cases, this entity may approve or deny a request for the insurance, and may also upload documents where needed.

A seller's lawyer may also be part of the transaction. For example, the lawyer may initiate the contract for the sale of the property, provide updated revisions until accepted by both parties, provide disbursement documents, provide proof of no encumbrances or lien releases on payment, provide title search documents for proof of ownership, provide other documents and workflow steps as required, and managed the deposit return if conditions are not met by the seller.

A buyer's lawyer may also be part of the transaction utilizing the system of FIGS. 1 to 5 and therefore have a role. For example, the buyer's lawyer may review the contract, make digital comments on the contract, approve a clean contract, request a client to digitally sign the contract, review all uploaded documents from the sellers lawyer, transfer any funds in escrow to the sellers lawyer, and manage the deposit and payment from the bank to the seller's lawyer, among other functions.

An appraiser may also be a role within the system of FIGS. 1 to 5. For example, the appraiser may be hired by a buyer to ensure that the property has the value stated. The appraiser may upload an appraisal report in some cases.

An inspector may also be a role within the system of FIGS. 1 to 5. For example, the inspector may be hired by a buyer to ensure that there are no major faults with the property that may have an effect on waiving conditions of the offer. The inspector may upload an inspection report in some cases.

A Land Registry may have a role in both title transfer and land transfer taxes.

Government agencies may have roles with regard to property taxes, including entering a balance as of the transaction close date to ensure that these are fully paid by the seller and that the buyer is not inheriting any past debt.

Title insurers may allow the purchase of insurance in the event that any fraud exists and that the seller does not have the authority to sell the property. In some cases, the title insurance provider can be invited to participate and upload their policy. In other cases, this may be done by a buyer's lawyer.

In some cases, a cryptocurrency platform may be used for a stable coin or digital cryptocurrency coin that represents a non-fluctuating currency that can be used for the deposit or purchase. Such platform may ensure that the deal closes and the currency can be converted to cover disbursements and payments needed to close the deal. The use of such platform may allow the avoidance of getting a bank draft or certified check manually. For example, such cryptocurrency platform may be associated with a bank or institution, or maybe government backed in some cases, and may handle digital exchange of currencies seamlessly and efficiently with full auditability and controls with each step of the transaction to be stored on the blockchain with the smart contracts that will move it to the next step when all the checks and balances and authorized permissions and conditions have been met.

As all information about the transaction can be put into the blockchain, security and permissioned based access is provided to the one single source of truth. The blockchain does not pass copies of information but provides permission to access to the one and only version of the original information in the embodiments of the present disclosure.

### Deal Application

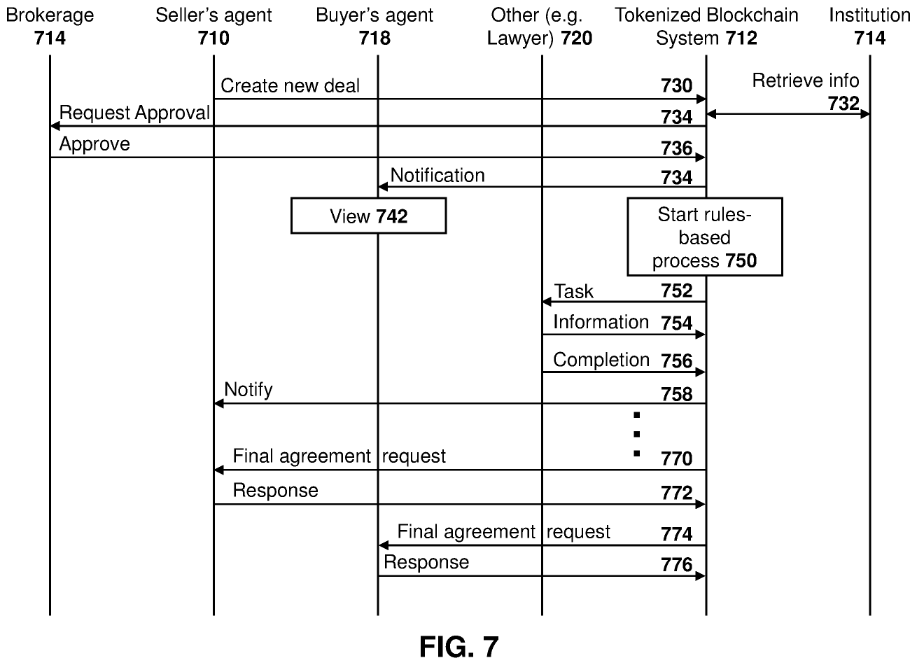

Reference is now made to FIG. 7, which shows an example flow through a deal application. In particular, a selling agent 710 may communicate with the tokenized blockchain system 712. Other actors may include third party or government institutions 714, the selling brokerage 716, the buyers agent 718, other actors such as lawyers 720, other real estate professionals, among others. The embodiment of FIG. 7 could have other actors and is shown provided with limited parties for illustration purposes only.

Further, while the example of FIG. 7 provides for a selling agent 710 to be a “first party” to the transaction, in some cases other real estate professionals could also or instead perform the functions described herein, and in some cases may initiate the transaction. As such, the present disclosure is not limited to a party being an agent. The use of the selling agent 710 in the example of FIG. 7 is therefore merely provided for illustrative purposes.

The selling agent 710 may have access to the tokenized blockchain system 712 from their computer, mobile device or other computing device. A deal application may leverage a significant portion of the tokenized blockchain system 712 Infrastructure for managing the block chain, workflow, security, CRM, notifications, portal security and mobile tool for interacting with the workflow from anywhere. Such interaction may include notifications, uploading documents, acknowledgements, reading messages, taking a picture and uploading it to the deal block chain, among other interactions. This may be done through a dedicated application loaded onto the user's computing device.

The deal creator, which in the embodiment of FIG. 7 is the selling agent 710, can define a new deal and provide the required information to the tokenized blockchain system 712. This is shown with message 730. Much of the information for the new deal will be found in other information within the system, including templates, company or personal CRM data, a self sovereign identity for the selling agent 710, among other information. Further, the tokenized blockchain system 712 may retrieve information as shown with message 732 from an institution or third party 714.

Message 730 may include the selection of participants or creation of those participants for the deal.

Thus, the deal creator could create the deal, including in some cases choosing the deal block chain type, importing the MLS listing as the subject of the deal, for example by using an MLS property number, adding new individuals to the CRM, adding all the participants from the CRM to the specific deal and assigning their role in the deal, among other functionality.

In some embodiments, message 730 may require approval of a selling brokerage 716. For example, this may be to avoid fraud. In this case, the tokenized blockchain system 712 may request the approval from brokerage 716, as shown with message 734, and received approval, as shown with message 736.

In other cases, other participants in the deal may also need to approve the deal prior to it being started.

The roles assigned in message 730 could be used in templates for what access to different blocks in the blockchain a participant will have. For example, a buyer or buyer's agent may need to waive conditions on a deal, such as home inspection and thus may have access to certain blocks on the blockchain.

In some cases, all participants in the transaction may be able to read the legal contracts, but only the buyers lawyer and the sellers lawyer can post changes to such contract. In some cases, the buyer and the seller can have rights to digitally sign the contracts if allowable in their jurisdiction, and/or upload the final accepted contract in other cases.

Once approval is received, a notification may be sent from the tokenized blockchain system 712 to the participants identified in message 730. In the example of FIG. 7, this is shown as notification 740, which is sent to the buyer's agent 718. In other embodiments, the notification may be sent to the buyers brokerage, to the buyers themselves if they are registered in the system or if contact information was provided In message 730, or to other actors for the transaction. Notification 740 may be sent by e-mail, SMS, or through other means, and may be defined by a user in their preferences.

Notification 740 may include a hyperlink which would allow the receiving party to click and immediately view the deal, as shown for example with block 742.

The deal participants are defined by the deal creator and are invited to participate in the deal, for example by e-mail or text message as soon as the deal is set up and approved. Such participants may continue to be notified on each step of the deal with where they need to participate. Various steps may allow read only access to documents. In other cases, the participant may need to update certain documentation or provide information. In this regard, at anytime a deal participant can enter the deal application and see everything that they have access to that is part of the deal. For example, the participant may read, update access to various steps, and add blocks at anytime while the deal is still active. Specific roles within this area may be further defined to provide application functionality based on role type.

Some embodiments, the deal may be 100% web-based using services provided by the tokenized blockchain system 712. It is secured by a device certificate and by a user ID and password for each interaction with the application. The deal application may timeout automatically with inactivity and log the user out. When accessing the application, a check may be made to determine whether a certificate exists and if yes, prompt for user ID or password. Such password may change periodically for additional security reasons. In some cases, rather than a password, a personal identification number may be used. Each login is saved into the event monitoring audit system.

Further, other features that are geared to the device accessing the application can be made. For example, if the device access in the application is a mobile phone, then a version of the interface optimized for the mobile application may be provided, sometimes only providing a subset of features that are offered on a computing device but that may be geared to an agent or client on the move. In some cases, the computing device application may be enabled for touch screens. In all cases, various features such as deal creation, approval, CRM management, setting up security, broadcasting messages to various participants in the deal, allowing for two-way communications from a message center, among other features, may be provided to the user of the application. The application may provide for access to artificial intelligence chat bots to assist or provide a help center.

The options presented to a user may be defined by their role. For example, a buyer or seller may have fewer options than a buyer's agent or a seller's agent.

Further, if the user is involved with more than one deal, for example as a buyer agent or seller agent, they may be prompted to select the deal that they are interested in from a plurality of available deals. If accessing the deal directly from an initial notification email or text message, then they will be brought directly into the initiating deal.

In addition to an in-application message centre, communications may flow through specified e-mail, SMS or other communication means.

Once the deal is started, then the workflow for the type of transaction may be started, as shown at block 750. The starting of the workflow may cause notifications to one or more other users that have a task that needs to be completed. For example, in the embodiment of FIG. 7, if a lawyer was specified by the selling agent, then a task 752 may be provided to the lawyer 720. The lawyer may then provide information to the tokenized blockchain system 712, for example by uploading contracts, Land Registry searches, utility information, etc., as shown with messages 754. Further, once the task is complete, the lawyer 720 may provide an indication that the task is complete at message 756.

The information provided in message 754 may be stored as a block on the transaction blockchain, for example. Thus each block on the transaction blockchain may be a workflow step that is completed. If a mistake is made, the block may be “edited” by creating a new block in the transaction blockchain that is a corrective block.

Parties to the transaction may be notified of the completion of the task, for example as shown with notification message 758. While the embodiment of FIG. 7 only shows one notification, the notifications may be sent based on rules or workflows and may be provided to multiple parties.

While the task 752 is shown to be provided to a lawyer 720, various parties in the transaction could receive tasks, including, but not limited to, lawyers, financial institutions, brokers, registration agencies, appraisers, insurers, among others, and each can participate in the deal directly or through another party such as the agent or the actual buyer or seller themselves if they are representing themselves. All such parties may be able to upload a document, provide details, pictures, agreements, approvals that have come from these external deal participants.

The participation in the deal may also be supported by the API to automate and speed up the deal process with institutions that can integrate with the tokenized blockchain system 712 to automate and speed up the deal process with such institutions. For example, the tokenized blockchain system 712 may integrate document management services typically used by service providers. Other integrations are possible.

Further, the use of digital approvals can be used by the tokenized blockchain system 712, for example using certificate or user based signatures, on screen physical signatures, or by traditional third party products such as DocuSign or Adobe sign PDF signature tools, or both.

The flow may continue, either serially or in parallel depending on the workflow, until all tasks are complete. Once everything is complete, a final agreement request may be provided to all parties from the tokenized blockchain system 712. For example, in the embodiment of FIG. 7, the final agreement request 770 is sent to the selling agent 710 and a response 772 is received from the selling agent 710. Further, the final agreement request 774 is sent to the buyer's agent 718 and a response 776 is received from the buyer's agent 718. However, in other cases, the final agreement request may be sent to other parties.

The deal will be fully closed when consensus is reached and a final summary document or report for all components can be then sent to designated participants. The closed deal may be accessible at anytime in perpetuity or until the deal is archived or purged, if ever.

All parts of the deal are stored on the blockchain to ensure non repudiation and transparency.

Further, deals application can be used to add properties to the MLS system. In this case, the digital identity of the author entering new listings and storing such event for audit and legal purposes the content of the listing overtime. In some cases, a comparison delta of what has changed may be stored as well. Such delta may include price, availability, specifications, disclosures, among other information that could be kept in managed on the blockchain. The latest copy of the information will also likely reside in a relational database and be available for query and for building user interfaces online.

Thus, the blockchain can be used to help secure who made the listing, when changes were made, who made the changes, history of the property over many years or many owners, and can provide a property listing that can be trusted over decades to have a single version of the truth. Such information may be capable of being sold as a background check and historic records for such property.

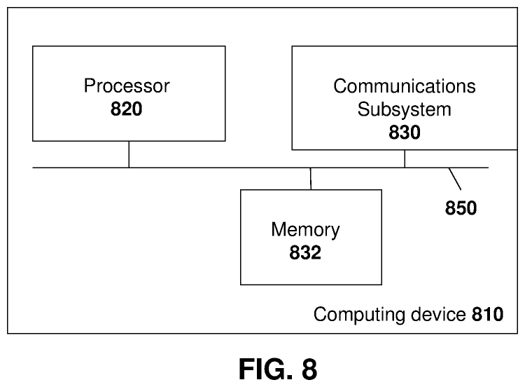

The above may be implemented using any computing device or combination of computing devices. One simplified diagram of a computing device is shown with regard to FIG. 8. The computing device of FIG. 8 could be any fixed or mobile computing device.

In FIG. 8, device 810 includes a processor 820 and a communications subsystem 830, where the processor 820 and communications subsystem 830 cooperate to perform the methods of the embodiments described above. Communications subsystem 830 allows device 810 to communicate with other devices or network elements and may vary based on the type of communication being performed. Further, communications subsystem 830 may comprise a plurality of communications technologies, including any wired or wireless communications technology.

Processor 820 is configured to execute programmable logic, which may be stored, along with data, on device 810, and shown in the example of FIG. 8 as memory 832. Memory 832 can be any tangible, non-transitory computer readable storage medium which stores instruction code that, when executed by processor 820 cause device 810 to perform the methods of the present disclosure. The computer readable storage medium may be a tangible or in transitory/non-transitory medium such as optical (e.g., CD, DVD, etc.), magnetic (e.g., tape), flash drive, hard drive, or other memory known in the art.

Alternatively, or in addition to memory 832, device 810 may access data or programmable logic from an external storage medium, for example through communications subsystem 830.

Communications between the various elements of device 810 may be through an internal bus 850 in one embodiment. However, other forms of communication are possible.

The embodiments described herein are examples of structures, systems or methods having elements corresponding to elements of the techniques of this application. This written description may enable those skilled in the art to make and use embodiments having alternative elements that likewise correspond to the elements of the techniques of this application. The intended scope of the techniques of this application thus includes other structures, systems or methods that do not differ from the techniques of this application as described herein, and further includes other structures, systems, or methods with insubstantial differences from the techniques of this application as described herein.

While operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be employed. Moreover, the separation of various system components in the implementation described above should not be understood as requiring such separation in all implementations, and it should be understood that the described program components and systems can generally be integrated together in a single software product or packaged into multiple software products.

Also, techniques, systems, subsystems, and methods described and illustrated in the various implementations as discrete or separate may be combined or integrated with other systems, modules, techniques, or methods. Other items shown or discussed as coupled or directly coupled or communicating with each other may be indirectly coupled or communicating through some interface, device, or intermediate component, whether electrically, mechanically, or otherwise. Other examples of changes, substitutions, and alterations are ascertainable by one skilled in the art and may be made.

While the above detailed description has shown, described, and pointed out the fundamental novel features of the disclosure as applied to various implementations, it will be understood that various omissions, substitutions, and changes in the form and details of the system illustrated may be made by those skilled in the art. In addition, the order of method steps are not implied by the order they appear in the claims.

When messages are sent to/from an electronic device, such operations may not be immediate or from the server directly. They may be synchronously or asynchronously delivered, from a server or other computing system infrastructure supporting the devices/methods/systems described herein. The foregoing steps may include, in whole or in part, synchronous/asynchronous communications to/from the device/infrastructure. Moreover, communication from the electronic device may be to one or more endpoints on a network. These endpoints may be serviced by a server, a distributed computing system, a stream processor, etc. Content Delivery Networks (CDNs) may also provide communication to an electronic device. For example, rather than a typical server response, the server may also provision or indicate a data for content delivery network (CDN) to await download by the electronic device at a later time, such as a subsequent activity of electronic device. Thus, data may be sent directly from the server, or other infrastructure, such as a distributed infrastructure, or a CDN, as part of or separate from the system.

Typically, storage mediums can include any or some combination of the following: a semiconductor memory device such as a dynamic or static random access memory (a DRAM or SRAM), an erasable and programmable read-only memory (EPROM), an electrically erasable and programmable read-only memory (EEPROM) and flash memory; a magnetic disk such as a fixed, floppy and removable disk; another magnetic medium including tape; an optical medium such as a compact disk (CD) or a digital video disk (DVD); or another type of storage device. Note that the instructions discussed above can be provided on one computer-readable or machine-readable storage medium, or alternatively, can be provided on multiple computer-readable or machine-readable storage media distributed in a large system having possibly a plurality of nodes. Such computer-readable or machine-readable storage medium or media is (are) considered to be part of an article (or article of manufacture). An article or article of manufacture can refer to any manufactured single component or multiple components. The storage medium or media can be located either in the machine running the machine-readable instructions, or located at a remote site from which machine-readable instructions can be downloaded over a network for execution.

In the foregoing description, numerous details are set forth to provide an understanding of the subject disclosed herein. However, implementations may be practiced without some of these details. Other implementations may include modifications and variations from the details discussed above. It is intended that the appended claims cover such modifications and variations.

1. A computerized method for securing and performing a transaction, the method comprising:
receiving, at a computing system from a first party, a request to start the transaction;
verifying the identity and a role for the first party;
identifying, from the request, a transaction type and parties to the transaction;
starting a workflow for the transaction based on the transaction type;
sending, based on the workflow, requests for information to the parties to the transaction;
receiving the information; and
storing the information in a blockchain for the transaction.

2. The method of claim 1, wherein the verifying the identity is based on a single sign on and a credential identifying a user and a device.

3. The method of claim 1, wherein the verifying comprises:
receiving confirmation of identity from an authorized party within the computing system,
sending a message to the first party to verify a communications channel; and
sending a certificate for a computing device being used by the first party to the first party for manual or automatic installation on the computing device.

4. The method of claim 1, wherein the transaction requires information, the information being populated from a self-sovereign identity stored in a block on the blockchain.

5. The method of claim 1, further comprising, after the verifying, ensuring authorization for the transaction to proceed.

6. The method of claim 1, wherein the computing system stores a plurality of workflows for various transaction types.

7. The method of claim 1, further comprising, once the workflow is completed:
sending a final agreement request to the first party and parties to the transaction;
receiving confirmation from the first party and the parties to the transaction that the transaction is completed; and
storing the completed transaction on the blockchain.

8. The method of claim 1, wherein the blockchain is a private blockchain that is accessible through an application program interface on the computing system.

9. The method of claim 1, wherein the transaction is a real estate transaction, and wherein the first party is an agent or real estate professional, and the parties to the transaction include one or more of a buyer, a seller, a buyer's agent, a seller's agent, a brokerage, a lawyer, a banker, a government institution, an insurance agent, an insurance company, and a real estate professional.

10. A computing system for securing and performing a transaction, the computing system comprising:
a processor;
a communications subsystem, and
memory,
wherein the computing system is configured to:
receive, from a first party, a request to start the transaction;
verify the identity and a role for the first party;
identify, from the request, a transaction type and parties to the transaction;
start a workflow for the transaction based on the transaction type;
send, based on the workflow, requests for information to the parties to the transaction;
receive the information; and
store the information in a blockchain for the transaction.

11. The computing system of claim 10, wherein the computing system is configured to verify the identity based on a single sign on and a credential identifying a user and a device.

12. The computing system of claim 10, wherein the computing system is configured to verify by:
receiving confirmation of identity from an authorized party within the computing system,
sending a message to the first party to verify a communications channel; and
sending a certificate for a computing device being used by the first party to the first party for manual or automatic installation on the computing device.

13. The computing system of claim 10, wherein the transaction requires information, the information being populated from a self-sovereign identity stored in a block on the blockchain.

14. The computing system of claim 10, wherein the computing system is further configured to ensure authorization for the transaction to proceed after verification.

15. The computing system of claim 10, wherein the computing system stores a plurality of workflows for various transaction types.

16. The computing system of claim 10, wherein the computing system is further configured to, once the workflow is completed:
send a final agreement request to the first party and parties to the transaction;
receive confirmation from the first party and the parties to the transaction that the transaction is completed; and
store the completed transaction on the blockchain.

17. The computing system of claim 10, wherein the blockchain is a private blockchain that is accessible through an application program interface on the computing system.

18. The computing system of claim 1, wherein the transaction is a real estate transaction, and wherein the first party is an agent or real estate professional, and the parties to the transaction include one or more of a buyer, a seller, a buyer's agent, a seller's agent, a brokerage, a lawyer, a banker, a government institution, an insurance agent, an insurance company, and a real estate professional.

19. A computer readable medium for storing instruction code for securing and performing a transaction, the instruction code, when executed by a processor of a computing system, cause the computing system to:
receive, from a first party, a request to start the transaction;
verify the identity and a role for the first party;
identify, from the request, a transaction type and parties to the transaction;
start a workflow for the transaction based on the transaction type;
send, based on the workflow, requests for information to the parties to the transaction;
receive the information; and
store the information in a blockchain for the transaction.
